(19) United States
(12) Patent Application Publication
(10) Pub. No.: US 2022/0052579 A1
(43) Pub. Date: Feb. 17, 2022

(54) MOTOR

(71) Applicant: LG INNOTEK CO., LTD., Seoul (KR)

(72) Inventor: Seong Jin KIM, Seoul (KR)

(21) Appl. No.: 17/274,624

(22) PCT Filed: Sep. 11, 2019
(86) PCT No.: PCT/KR2019/011808

§ 371 Date: Mar. 9, 2021

(30) Foreign Application Priority Data
Sep. 11, 2018 (KR) 10-2018-0108437

(51) Int. Cl. H02K 5/22; H02K 3/28; H02K 3/34; H02K 3/52; H02K 7/14

(52) U.S. Cl. CPC H02K 5/225; H02K 3/28; H02K 7/14; H02K 3/522; H02K 3/345

(57) ABSTRACT

The present invention may provide a motor comprising: a housing; a stator disposed in the housing; a rotor disposed in the stator; and a shaft coupled to the rotor. The stator comprises: a stator core; an insulator disposed on the stator core; and a coil disposed at the insulator. The insulator comprises: a body at which the coil is disposed; a first guide which is extended from one side of the body; and a first protrusion and a second protrusion which protrude from the upper surface of the first guide. The first protrusion and the second protrusion are disposed to be spaced apart from each other so as to form a space in the circumferential direction with reference to the center of the stator.

### TECHNICAL FIELD

Embodiments relate to a motor.

### BACKGROUND ART

A motor includes a shaft, a rotor, and a stator. The stator includes a plurality of teeth. For insulation, insulators are provided on the teeth. A coil is wound on the insulator. In the case of a motor to which power is dually supplied, two coils may be wound on one insulator. In this case, winding two times is necessary.

### DISCLOSURE

### Technical Problem

The present invention is directed to providing a motor in which two coils are wound on one insulator in a one-time winding process.

### Technical Solution

One aspect of the present invention provides a motor including a housing, a stator disposed in the housing, a rotor disposed in the stator, and a shaft coupled to the rotor. Here, the stator includes a stator core, an insulator disposed on the stator core, and a coil disposed on the insulator. The insulator includes a body on which the coil is disposed, a first guide extending from one side of the body, and a first protrusion and a second protrusion which protrude from a top surface of the first guide. Also, the first protrusion and the second protrusion are disposed to be spaced apart from each other to form a space in a circumferential direction on the basis of a center of the stator.

The first guide may include a first inner surface and a first outer surface. The first protrusion and the second protrusion may be disposed between the first inner surface and the first outer surface on the basis of a lateral direction of the first guide.

Each of the first protrusion and the second protrusion may include a second inner surface, a second outer surface, and a groove. The groove may be disposed on the second outer surface and disposed along the lateral direction of the first guide.

Each of the first protrusion and the second protrusion may be disposed while being spaced apart from an edge formed by the top surface and a side surface of the first guide.

On the basis of a reference line passing through a center of the body in a lateral direction, the first protrusion may be disposed on one side of the reference line. The second protrusion may be disposed on the other side of the reference line, and the first protrusion and the second protrusion may be disposed to be symmetrical on the basis of the reference line.

The body may include a first body and a second body disposed inside the first body, and the insulator may include a second guide protruding upward from the body between the first body and the second body.

The first protrusion and the second protrusion may include areas protruding further than the second guide in a lateral direction of the insulator.

The coil may include a first coil wound on the first body and a second coil wound on the second body.

The first coil may include a first end disposed on one side and a second end disposed on the other side on the basis of the reference line, and the second coil may include a third end disposed on one side and a fourth end disposed on the other side on the basis of the reference line.

The motor may include a terminal disposed above the stator. Here, the terminal may include a first terminal and a second terminal. The first terminal may be coupled to the first end and the third end, and the second terminal may be coupled to the second end and the fourth end.

The motor may include a terminal disposed above the stator. Here, the terminal may include a first terminal and a second terminal. The first terminal may include a 1-1 terminal and a 1-2 terminal. The second terminal may include a 2-1 terminal and a 2-2 terminal. The 1-1 terminal may be coupled to the first end. The 1-2 terminal may be coupled to the third end. The 2-1 terminal may be coupled to the second end, and the 2-2 terminal may be coupled to the fourth end.

The first terminal may be any one of a U-phase terminal, a V-phase terminal, and a W-phase terminal, and the second terminal may be a neutral terminal.

### Advantageous Effects

According to an embodiment, since positions of terminal ends of coils are aligned, advantageous effects in manufacturing automation and increasing a quality of fusing coils are provided.

### DESCRIPTION OF DRAWINGS

FIG. 1 is a view illustrating a motor according to an embodiment.

FIG. 2 is a view illustrating a stator core and an insulator.

FIG. 3 is a perspective illustrating the insulator.

FIG. 4 is a plan view illustrating the insulator.

FIG. 5 is a view illustrating a coated part of a coil.

FIG. 6 is a view illustrating a winding process.

FIG. 7 is a view illustrating the coil after being cut.

FIG. 8 is a view illustrating connection between a terminal and the coil.

FIG. 9 is a view illustrating connection between a terminal and a coil according to a modified example.

### MODES OF THE INVENTION

Hereinafter, exemplary embodiments of the present invention will be described in detail with reference to the drawings.

However, the technical concept of the present invention is not limited to some embodiments disclosed below but can be implemented in a variety of different forms. One or more of components of the embodiments may be selectively combined or substituted with another without departing from the scope of the technical concept of the present invention.

Also, unless defined otherwise, the terms (including technical and scientific terms) used herein may be used as meanings capable of being commonly understood by one of ordinary skill in the art. Also, terms defined in generally used dictionaries may be construed in consideration of the contextual meanings of the related art.

Also, the terms used herein are intended to describe the embodiments but not intended to restrict the present invention.

Throughout the specification, unless particularly stated otherwise, singular forms include plural forms. When stated as “at least one (or one or more) of A, B, and C,” one or more of all combinations of A, B, and C may be included.

Also, in describing components of the embodiments of the present invention, the terms such as first, second, A, B, (a), (b), and the like may be used.

These terms are merely for distinguishing one element from another, and the essential, order, sequence, and the like of corresponding elements are not limited by the terms.

Also, when it is stated that one element is “connected,” or “coupled” to another, the element may not only be directly connected or coupled to the other element but may also be connected or coupled to the other element with another intervening element.

Also, when it is stated that an element is formed or disposed “above or below” another element, the two elements may not only come into direct contact with each other but also still another element may be formed or disposed between the two elements. Also, being “above (on) or below (beneath)” may include not only being in an upward direction but also being in a downward direction on the basis of one element.

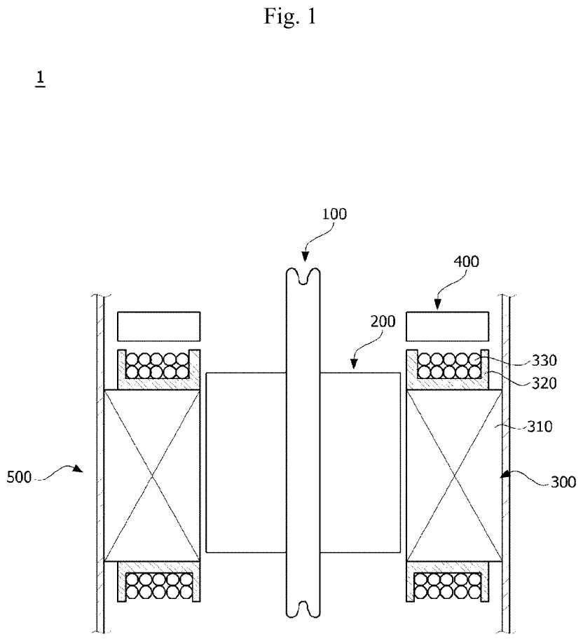

FIG. 1 is a view illustrating a motor according to an embodiment.

Referring to FIG. 1, the motor according to the embodiment may include a rotating shaft 100, a rotor 200, a stator 300, a busbar 400, and a housing 500.

The rotating shaft 100 may be coupled to the rotor 200. When electromagnetic interaction occurs between the rotor 200 and the stator 300 through current supply, the rotor 200 rotates and the rotating shaft 100 rotates in connection therewith. The rotating shaft 100 may be connected to a steering device of a vehicle and may transmit a force of assisting a steering force.

The rotor 200 and the stator 300 rotate through electrical interaction.

The rotor 200 may include a rotor core and a magnet. The rotor core may be implemented to be a shape in which a plurality of plates having a circular thin steel plate shape are stacked or to be one cylindrical shape. A hole to which the rotating shaft 100 is coupled may be formed in a center of the rotor core.

The stator 300 is disposed outside the rotor 200. The stator 300 may include a stator core 310, an insulator 320, and a coil 330. The insulator 320 is mounted on the stator core 310. The coil 330 is wound on the insulator 320.

The rotor 200 and the stator 300 may be accommodated inside the housing 500.

The busbar 400 may be disposed above the stator 300.

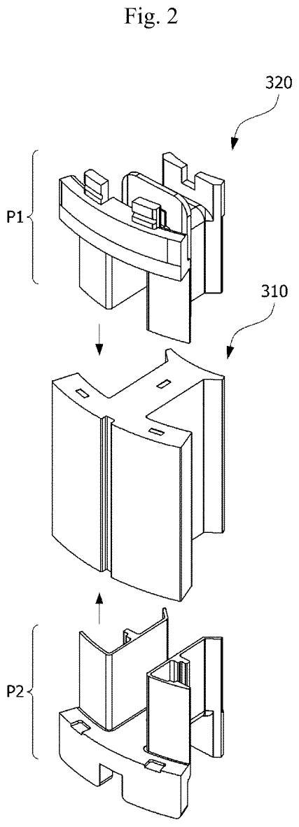

FIG. 2 is a view illustrating the stator core and the insulator.

Referring to FIG. 2, the insulator 320 is mounted on the stator core 310. The insulator 320 may include an upper part P1 and a lower part P2. The upper part P1 may be mounted on the stator core 310 from above, and the lower part P2 may be mounted on the stator core 310 from below.

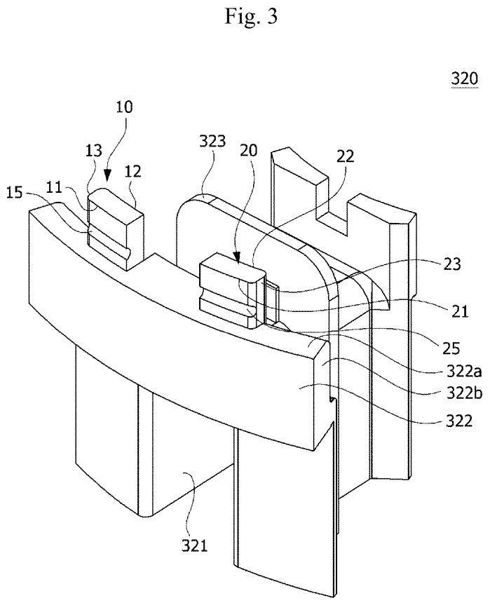

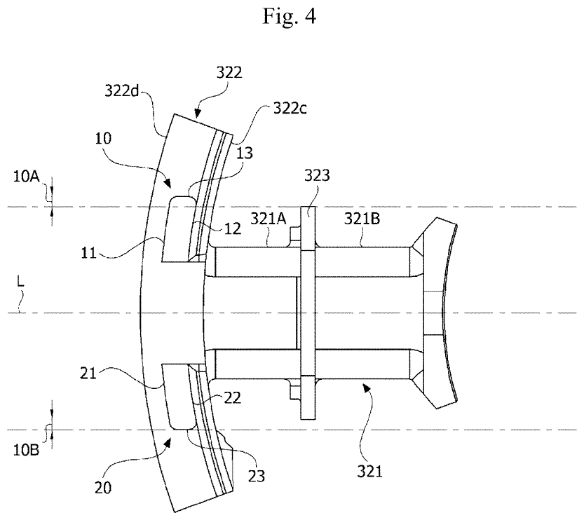

FIG. 3 is a perspective view of the insulator, and FIG. 4 is a plan view of the insulator.

Referring to FIG. 3, the insulator 320 may include a body 321, a first guide 322, and a second guide 323.

The body 321 is a part on which the coil 330 is wound and disposed. The body 321 may include a first body 321A and a second body 321B. On the basis of a radial direction of the stator 300, the first body 321A may be disposed outside the second body 321B. The second guide 323 is disposed on a boundary between the first body 321A and the second body 321B.

The first guide 322 is disposed extend upward from an outside of the body 321. The first guide 322 includes a first protrusion 10 and a second protrusion 20. The first protrusion 10 and the second protrusion 20 protrude from a top surface 322a of the first guide 322. The first protrusion 10 and the second protrusion 20 are aligned and disposed along a lateral direction of the first guide 322. Also, the first protrusion 10 and the second protrusion 20 are disposed to face each other with a space therebetween. The space between the first protrusion 10 and the second protrusion 20 is a space for cutting of the coil 330.

The first guide 322 may include a first inner surface 322c and a first outer surface 322d. The first protrusion 10 and the second protrusion 20 may be disposed between the first inner surface 322c and the first outer surface 322d on the basis of a radial direction.

The first protrusion 10 and the second protrusion 20 may include second outer surfaces 11 and 21, second inner surfaces 12 and 22, side surfaces 13 and 23, and grooves 15 and 25, respectively. The grooves 15 and 25 may be concavely disposed on the second outer surface 11. Also, the grooves 15 and 25 may be disposed along the lateral direction of the first guide 322.

Each of the first protrusion 10 and the second protrusion 20 may be disposed while being spaced apart from an edge formed by the top surface 322a and a side surface 322b of the first guide 322. This is to secure a detour space for the coil 330 being transferred to an outside of the first protrusion 10 or the second protrusion 20 after being wound.

On the basis of a reference line L passing a center of the first guide 322 in the lateral direction, the first protrusion 10 may be disposed on one side of the reference line L and the second protrusion 20 may be disposed on the other side of the reference line L. The first protrusion 10 and the second protrusion 20 may be disposed to be symmetrical on the basis of the reference line L.

This is to support the coil 330 being wound on the first protrusion 10 and the second protrusion 20 in a balanced way. Primarily, after the coil 330 is wound on the first body 321A, the coil 330 detours to the first protrusion 10 and the second protrusion 20 and then is guided to the second body 321B to be wound. Accordingly, supporting the coil 330 by the first protrusion 10 and the second protrusion 20 in a lateral direction of the insulator 320 in a balanced way becomes a significant factor in smoothly performing winding on the second body 321B.

The first protrusion 10 and the second protrusion 20 include protruding areas 10A and 10B, respectively. The protruding areas 10A and 10B protrude further than the second guide 323 in the lateral direction of the insulator 320. This is to secure a space for detouring to the first protrusion 10 after winding on the first body 321A. Also, this is to secure a space for the coil 330 being guided to the second body 321B to start winding thereon after detouring to the first protrusion 10 and the second protrusion 20.

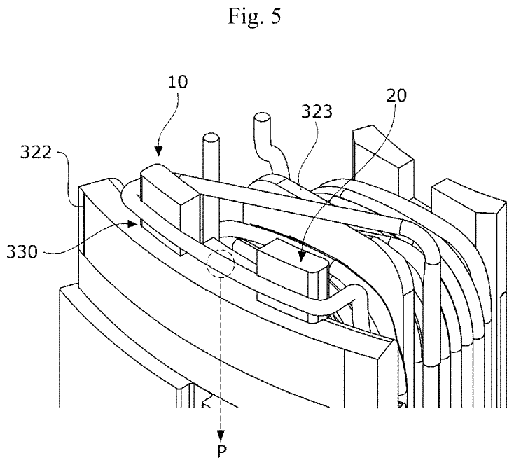

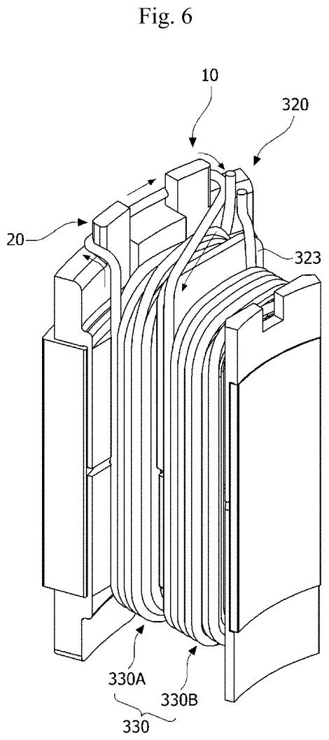

FIG. 5 is a view illustrating a coated part of the coil, and FIG. 6 is a view illustrating a winding process.

Referring to FIGS. 5 and 6, cutting is performed in a cutting area P of the coil 330 located between the first protrusion 10 and the second protrusion 20.

After the winding on the first body 321A is completed, the coil 330 is guided to the outside of the second protrusion 20. Also, the coil 330 passes around the second protrusion 20 and the first protrusion 10 and is guided toward the second body 321B. The coil 330 passes around the first protrusion 10 and is completely wound on the second body 321B. When the winding is completed, the coil 330 is disposed in the space between the first protrusion 10 and the second protrusion 20. Also, cutting is performed in the cutting area P.

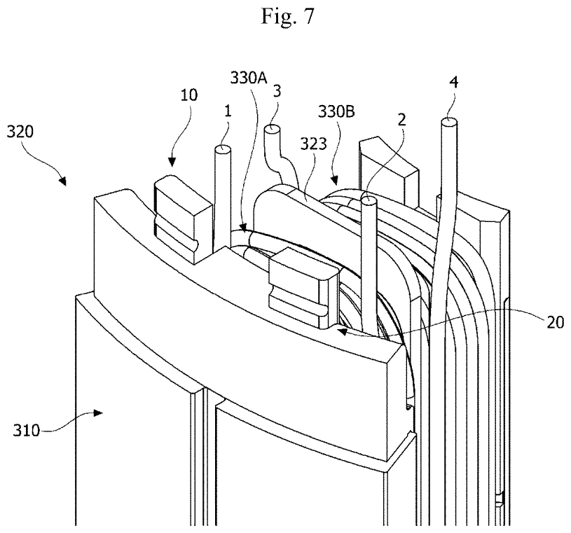

FIG. 7 is a view illustrating the coil after being cut.

Referring to FIGS. 6 and 7, when the cutting is performed, the coil 330 is divided into a first coil 330A and a second coil 330B. The first coil 330A has been wound on the first body 321A. The second coil 330B has been wound on the second body 321B. The first coil 330A includes a first end 1 and a second end 2. The second coil 330B includes a third end 3 and a fourth end 4. The second end 2 and the fourth end 4 are formed by cutting.

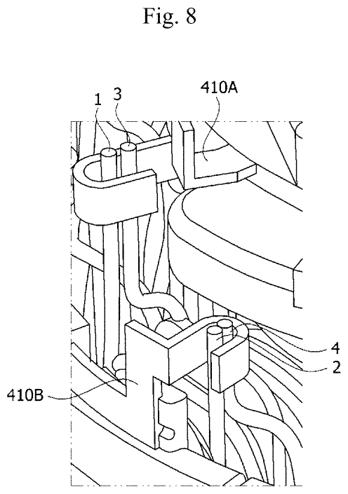

FIG. 8 is a view illustrating connection between a terminal and the coil.

Referring to FIG. 8, the first end 1 and the third end 3 may be fused and connected to a first terminal 410A together. The first terminal 410A may be one of a U-phase terminal, a V-phase terminal, and a W-phase terminal.

The second end 2 and the fourth end 4 may be fused and connected to a second terminal 410B together. The second terminal 410B may be a neutral terminal.

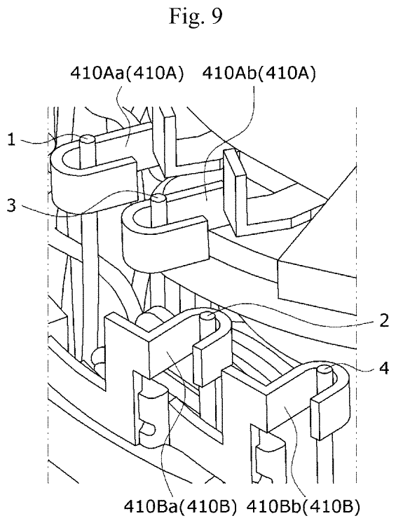

FIG. 9 is a view illustrating connection between a terminal and a coil according to a modified example.

Referring to FIG. 9, the first terminal 410A may include a 1-1 terminal 410Aa and a 1-2 terminal 410Ab. The 1-1 terminal 410Aa and the 1-2 terminal 410Ab may be electrically separated from each other. The second terminal 410B may include a 2-1 terminal 410Ba and a 2-2 terminal 410Bb. The 2-1 terminal 410Ba and the 2-2 terminal 410Bb may be electrically separated from each other.

The first coil 330A and the second coil 330B may be electrically separated.

The first end 1 of the first coil 330A may be coupled to the 1-1 terminal 410Aa. The third end 3 of the second coil 330B may be coupled to the 1-2 terminal 410Ab. The second end 2 of the second coil 330B may be coupled to the 2-1 terminal 410Ba. The fourth end 4 of the second coil 330B may be coupled to the 2-1 terminal 410Bb. Here, each of the 1-1 terminal 410Aa and the 1-2 terminal 410Ab may be any one of a U-phase terminal, a V-phase terminal, and a W-phase terminal. Also, the 2-1 terminal 410Ba and the 2-2 terminal 410Bb may be neutral terminals.

1. A motor comprising:
a housing;
a stator disposed in the housing;
a rotor disposed in the stator; and
a shaft coupled to the rotor,
wherein the stator comprises a stator core, an insulator disposed on the stator core, and a coil disposed on the insulator,
wherein the insulator comprises a body on which the coil is disposed, a first guide extending from one side of the body, and a first protrusion and a second protrusion which protrude from a top surface of the first guide, and
wherein the first protrusion and the second protrusion are disposed to be spaced apart from each other to form a space in a circumferential direction on the basis of a center of the stator,
wherein the body comprises a first body and a second body disposed inside the first body, and
wherein the insulator comprises a second guide protruding upward from the body between the first body and the second body,
wherein the first protrusion and the second protrusion comprise areas protruding further than the second wide in a lateral direction of the insulator.

2. The motor of claim 1, wherein the first guide comprises a first inner surface and a first outer surface, and
wherein the first protrusion and the second protrusion are disposed between the first inner surface and the first outer surface on the basis of a lateral direction of the first guide.

3. The motor of claim 2, wherein each of the first protrusion and the second protrusion comprises a second inner surface, a second outer surface, and a groove, and
wherein the groove is disposed on the second outer surface and disposed along the lateral direction of the first guide.

4. The motor of claim 2, wherein the first protrusion and the second protrusion are disposed to be spaced apart from an edge formed by a side surface and the top surface of the first guide.

5. The motor of claim 1, wherein, on the basis of a reference line passing through a center of the body in a lateral direction, the first protrusion is disposed on one side of the reference line,
wherein the second protrusion is disposed on the other side of the reference line, and
wherein the first protrusion and the second protrusion are disposed to be symmetrical on the basis of the reference line.

6-7. (canceled)

8. The motor of claim 1, wherein the coil comprises a first coil wound on the first body and a second coil wound on the second body.

9. The motor of claim 8, wherein the first coil comprises a first end disposed on one side and a second end disposed on the other side on the basis of the reference line, and
wherein the second coil comprises a third end disposed on one side and a fourth end disposed on the other side on the basis of the reference line.

10. The motor of claim 9, comprising a terminal disposed above the stator,
wherein the terminal comprises a first terminal and a second terminal,
wherein the first terminal is coupled to the first end and the third end, and
wherein the second terminal is coupled to the second end and the fourth end.

11. The motor of claim 9, comprising a terminal disposed above the stator,
wherein the terminal comprises a first terminal and a second terminal,
wherein the first terminal comprises a 1-1 terminal and a 1-2 terminal,
wherein the second terminal comprises a 2-1 terminal and a 2-2 terminal,
wherein the 1-1 terminal is coupled to the first end,
wherein the 1-2 terminal is coupled to the third end,
wherein the 2-1 terminal is coupled to the second end, and
wherein the 2-2 terminal is coupled to the fourth end.

12. The motor according to claim 10, wherein the first terminal is any one of a U-phase terminal, a V-phase terminal, and a W-phase terminal, and wherein the second terminal is a neutral terminal.

13. The motor according to claim 11, wherein the first terminal is any one of a U-phase terminal, a V-phase terminal, and a W-phase terminal, and
wherein the second terminal is a neutral terminal.
